(19) United States
(12) Patent Application Publication
(10) Pub. No.: US 2009/0280365 A1
(43) Pub. Date: Nov. 12, 2009

(54) FUEL CELL SYSTEM AND METHOD OF STARTING A FUEL CELL SYSTEM

(75) Inventors: Stefan Kading, Zerrenthin (DE); Norbert Gunther, Rabnitz Damgarten (DE); Jeremy Lawrence, Dresden (DE); Su Zhou, Shanghai (CN)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,220

(22) PCT Filed: Jul. 17, 2007
(86) PCT No.: PCT/DE07/01275

§ 371 Date: Mar. 5, 2009

(30) Foreign Application Priority Data
Sep. 11, 2006 (DE) 10 2006 042 537.5

(51) Int. Cl. H01M 8/04; H01M 8/18

(52) U.S. Cl. 429/17; 429/20

(57) ABSTRACT

The invention relates to a method of starting up a fuel cell system comprising a reformer (10) and a fuel cell stack (12), the reformer receiving a supply of fuel (14) and air (16) as the starting materials and the fuel cell stack receiving a supply of reformate (18) generated by the reformer.

In accordance with the invention it is provided for that the air ratio characterizing the fuel/air ratio of the starting materials supplied to the reformer (10) is varied as a function of a temperature of the fuel cell stack (12).

The invention relates furthermore to a fuel cell system.

The invention relates to a method of starting up a fuel cell system comprising a reformer and a fuel cell stack, the reformer receiving a supply of fuel and air as the starting materials and the fuel cell stack receiving a supply of reformate generated by the reformer.

The invention relates furthermore to a fuel cell system comprising a reformer and a fuel cell stack, the reformer receiving a supply of fuel and air as the starting materials and the fuel cell stack receiving a supply of reformate generated by the reformer.

In generic fuel cell systems electricity is generated in a fuel cell stack. For this purpose the fuel cell stack receives a supply of air and a hydrogen rich reformate, the latter being generated in a reformer from fuel and an oxidant, particularly air. To optimize the H₂ yield the reformers work with air ratios, characterizing the ratio of fuel to air, of 0.4 or lower.

Solid oxide fuel cell (SOFC) systems have operating temperatures exceeding 800° C. which need to be attained in the start-up phase. The thermal energy needed for this purpose is furnished by the hot gases streaming from the reformer as well as by preheated cathode feed air to the fuel cell stack. Such a start-up phase poses a number of problems. For one thing, because of the air ratios usually being low for reformer operation, but especially because of low temperatures the fuel cell stack may become sooted up which by blocking the electrodes can result in the fuel cell stack being ruined. For another, when temperatures and air ratios are high there is a risk of the anode material in the fuel cell stack being ruined by oxidation. It is only in stationary operating of the fuel cell stack, i.e. when the aforementioned high temperatures exceed 800° C. and the air ratios are as low as 0.4, for example, that sooting up and oxidation of the anode material become less of a problem.

The invention is based on the object of providing a method of starting up a fuel cell system and one such fuel cell system, so that even in the start-up phase of the fuel cell system, damage to the fuel cell stack by sooting up and oxidation is prevented.

This object is achieved by the features of the independent claims.

Advantageous embodiments of the invention read from the dependent claims.

The invention is a sophistication over the generic method in that the air ratio characterizing the fuel/air ratio of the starting materials supplied to the reformer is varied as a function of a temperature of the fuel cell stack. Varying the air ratio as a function of the temperature of the fuel cell stack now makes it possible at any time in operation, i.e. particularly during start-up of the fuel cell system, to set uncritical combinations of air ratio and temperature.

This now achieves that the air ratio can be reduced with increasing temperature of the fuel cell stack in thus enabling the start-up phase to commence with a high air ratio and a low temperature, in other words with a combination of the critical parameters which inhibit both sooting up as well as oxidation of the anode material. Now, when the temperature in the fuel cell stack increases, the air ratio can be gradually decreased in maintaining uncritical air ratio/temperature combinations until the combination typical for continuous operation is attained.

In accordance with a particularly preferred embodiment of the method in accordance with the invention it is provided for that on start-up of the fuel cell system an air ratio is set in the range 1.3 to 1.5 and that after having attained the operating temperature of the fuel cell stack an air ratio is set in the range 0.3 to 0.5.

It may be provided for that the air ratio can be reduced incrementally with increasing temperature of the fuel cell stack. This is a particularly practical solution since it now enables the air ratio to be corrected as a function of the momentary temperature value, if needed.

It is, however, just as possible to continuously reduce the air ratio with increasing temperature of the fuel cell stack in thus enabling the air ratio/time function to be optimally adapted to the temperature/time function.

The invention is sophisticated to particular advantage in that the temperature of the fuel cell stack is sensed in thus enabling suitable air ratios to be set as a function of the sensed temperature values.

Again, however, it is just as possible to use a value as established empirically as a function of the operating time of the fuel cell system as the temperature of the fuel cell stack. If the fuel cell system is sufficiently mature technically as regards its start-up properties, the temperature development of the fuel cell stack can thus be forecasted on the basis of empirical values. Then, there is no need to sense the temperature in the fuel cell stack. The empirical values may be sufficient to establish and then to set the suitable air ratios during start-up.

The invention is a sophistication over the generic fuel cell system in that the air ratio characterizing the fuel/air ratio of the starting materials supplied to the reformer is varied as a function of the temperature of the fuel cell stack in thus achieving the advantages and special features of the method in accordance with the invention also in the scope of a system. This applies also to particularly preferred embodiments of the fuel cell system in accordance with the invention as recited in the following.

The system is sophisticated particularly useful in that the fuel cell system comprises an electronic controller. Such an electronic controller handles establishing and setting the air ratio as a function of the temperature in accordance with the invention. The electronic controller may be made available dedicated to the fuel cell system. It is, however, just as possible that the controller is integrated in an already existing electronic controller, particularly in the motor vehicle. In this case the controller can be designed so that in the provides open and closed loop control respectively of all functions of the fuel cell system.

It is expediently provided for that the dependence of the air ratio to be varied from the temperature is saved in a memory belonging to the electronic controller.

The fuel cell system in accordance with the invention is sophisticated to advantage in that the air ratio can be reduced with increasing temperature of the fuel cell stack.

It is particularly preferred that on start-up of the fuel cell system an air ratio in the range 1.3 to 1.5 can be set and that after having attained the operating temperature of the fuel cell stack an air ratio can be set in the range 0.3 to 0.5.

In accordance with one variant of the fuel cell system in accordance with the invention it is provided for that the air ratio can be reduced incrementally with increasing temperature of the fuel cell stack.

On the other hand the system may also be sophisticated by it being possible to continuously reduce the air ratio with increasing temperature of the fuel cell stack.

It may prove expedient that at least one temperature sensor is provided to sense the temperature of the fuel cell stack.

It may likewise be of advantage to use a value as established empirically as a function of the operating time of the fuel cell system as the temperature of the fuel cell stack, the values being made available by a memory as a component of the electronic controller.

The invention will now be detailed by way of particularly preferred embodiments with reference to the attached drawings in which:

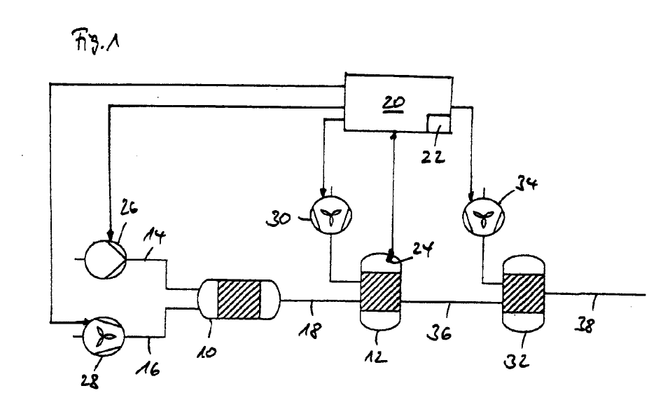

FIG. 1 is a diagrammatic representation of a fuel cell system;

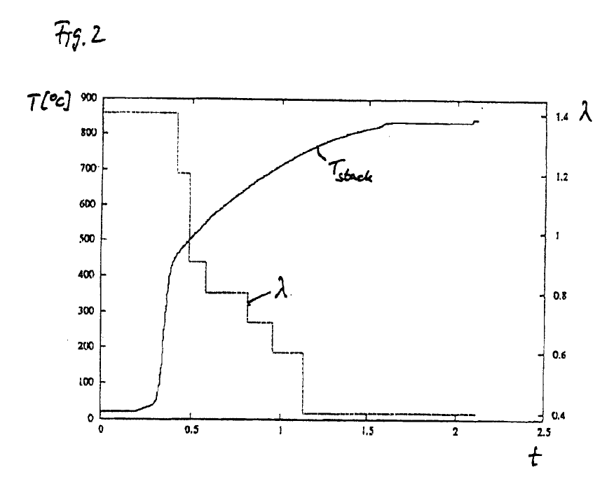

FIG. 2 is a graph showing a temperature/time plot and an air ratio/time plot as a function thereof in accordance with the invention;

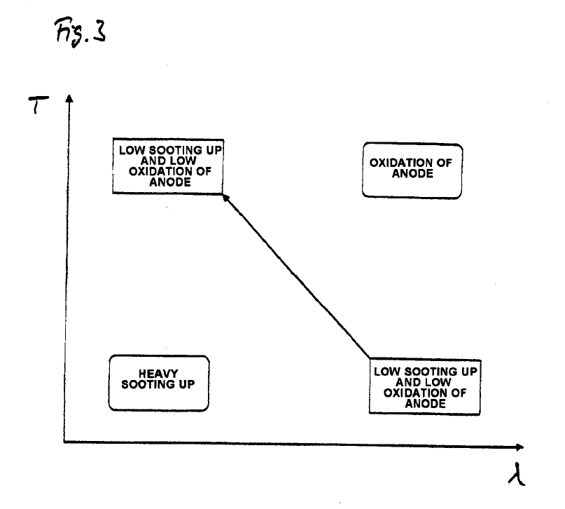

FIG. 3 is a graph showing a temperature/air ratio plot to assist in explaining the present invention, and

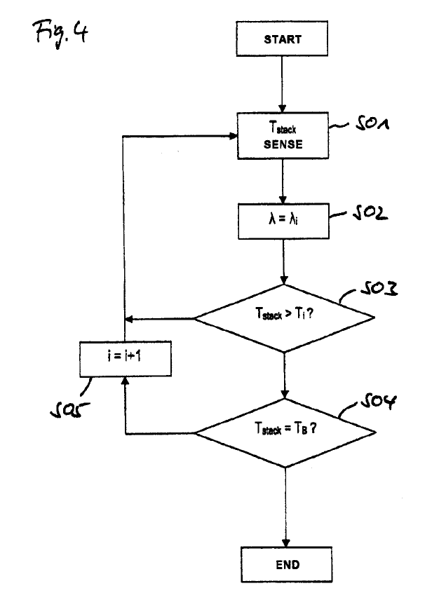

FIG. 4 is a flow chart to assist in explaining the present invention.

Referring now to FIG. 1 there is illustrated a diagrammatic representation of a fuel cell system. The fuel cell system comprises a fuel feeder 26, i.e. particularly a fuel pump, and an air feeder 28, i.e. particularly a blower, both coupled to the input of a reformer 10. At the output end the reformer 10 is coupled to the anode end of a fuel cell stack 12, the cathode end of which is connected to an air feeder 30, i.e. particularly a blower.

The fuel cell stack 12 features a temperature sensor 24. At its output end the fuel cell stack 12 is connected to am afterburner 32 which is likewise connected to an air feeder 34, i.e. particularly a blower. Also provided is an electronic controller 20 including a memory 22 connected to the sensors of the system, i.e. particularly the temperature sensor 24 of the fuel cell stack 12 for receiving the signals. The electronic controller 20 is furthermore in connection with the fuel feeder 26 as well as with the air feeders 28, 30, 34 to tweak their operation and in the scope of closed loop control, respectively.

In operation of the system the fuel feeder 26 and air feeder 28 feed fuel 14 and air 16 respectively to the reformer 10. In the reformer a hydrogen rich reform ate 18 materializes which is fed to the anode end of the fuel cell stack 12. The cathode end of the fuel cell stack 12 receives a supply of cathode feed air via the air feeder 30. This cathode feed air is expediently preheated. The reformate 36 depleted in the fuel cell stack 12 is 20 fed to an afterburner 32 which likewise receives a supply of air from the air feeder 34 for implementing combustion preferably free of residuals. The output of the afterburner 32 is exhaust gas 38, the thermal energy of which can be returned to the heat balance of the fuel cell system, for example, to preheat the cathode feed air forwarded by the air feeder 30.

In accordance with the invention on start-up of the fuel cell system it is provided for that the air ratio λwith which the reformer 10 is operated can be set as a function of the temperature of the fuel cell stack 12 as sensed by the temperature sensor 24 by the electronic controller 20 tweaking the fuel feeder 26 and/or the air feeder 28. The setting 30 is made so that uncritical air ratio/temperature combinations materialize particularly as regards sooting up of the fuel cell stack 12 and oxidation of the anode material in the fuel cell stack 12.

Referring now to FIG. 2 there is illustrated a graph showing a temperature/time plot and an air ratio/time plot as a function thereof in accordance with the invention. Illustrated is an exemplary temperature curve of the fuel cell stack plotted as a function of time. The temperature T_{stack} is based on a starting temperature value, for example, room temperature, and then quickly increasing to temperatures in the region of 500° C. before then approaching the operating temperature of the fuel cell stack of approx 850° C. It is as a function of this that the air ratio λ of the reformer can be set, namely on the basis of λ=1.4 before then decreasing down to a value of λ=0.4. It is not necessary that λ is varied as shown incrementally, a continual curve of the air ratio being just as practical. The air ratio values λ to be set for specific temperatures T_{stack} are expediently saved in a controller in the form of a table. In addition to the measured temperature T_{stack} also an empirically determined temperature T_{stack} as a function of time can be stored in a memory of a controller.

Referring now to FIG. 3 there is illustrated a graph showing a temperature/air ratio plot to assist in explaining the present invention. This illustrates that when temperatures are low and air ratios are low sooting up occurs whilst when temperatures are high and air ratios high unwanted oxidation of the anode can occur. Thus when low temperatures exist a high air ratio is selected in accordance with the invention at which sooting up and oxidation of the anode are minimized. It is on the basis of this that when the temperature increases the air ratio can be reduced until the operating temperature and the air ratio as expedient for reformer operation are attained.

Referring now to FIG. 4 there is illustrated a flow chart to assist in explaining the present invention. For system start-up firstly in step S01 the temperature T_{stack} of the fuel cell stack is sensed. In step S02 a specific air ratio λᵢ can be set. In step S03 a check is made as to whether the temperature T_{stack} of the fuel cell stack has exceeded a predefined temperature Tᵢ. If not, the method continues with step S01, i.e. the λ value remains unchanged and the temperature T_{stack} of the fuel cell stack is again sensed. If, however, in step S03 the temperature T_{stack} of the fuel cell stack exceeds the predefined temperature Tᵢ a check is made in step S04 as to whether the fuel cell stack has already attained its operating temperature. If not, then in step S05 the index i is elevated by 1 to then progress to step S01, the air ratio A being set to a lower air ratio Aᵢ₊₁.

But if in step S04 it is _{“}seen” that the fuel cell stack has attained its operating temperature, the start-up method of the fuel cell system is terminated.

It is understood that the features of the invention as disclosed in the above description, in the drawings and as claimed may be essential to achieving the invention both by themselves or in any combination.

### LIST OF REFERENCE NUMERALS

10 reformer
12 fuel cell stack
14 fuel
16 air
18 reformate
20 controller
22 memory
24 temperature sensor
26 fuel feeder
28 blower
30 blower
32 afterburner
34 blower
36 reformate
38 exhaust gas

1. A method of starting up a fuel cell system comprising a reformer (10) and a fuel cell stack (12), the reformer receiving a supply of fuel (14) and air (16) as the starting materials and the fuel cell stack receiving a supply of reformate (18) generated by the reformer, characterized in that the air ratio characterizing the fuel/air ratio of the starting materials supplied to the reformer (10) is varied as a function of a temperature of the fuel cell stack (12).

2. The method of starting up a fuel cell system as set forth in claim 1, characterized in that the air ratio is reduced with increasing temperature of the fuel cell stack (12).

3. The method of starting up a fuel cell system as set forth in claim 1 or 2, characterized in that on start-up of the fuel cell system an air ratio in the range 1.3 to 1.5 is set and that after having attained the operating temperature of the fuel cell stack (12) an air ratio is set in the range 0.3 to 0.5.

4. The method of starting up a fuel cell system as set forth in any of the preceding claims, characterized in that the air ratio is reduced incrementally with increasing temperature of the fuel cell stack (12).

5. The method of starting up a fuel cell system as set forth in any of the preceding claims, characterized in that the air ratio is continuously reduced with increasing temperature of the fuel cell stack (12).

6. The method of starting up a fuel cell system as set forth in any of the preceding claims, characterized in that the temperature of the fuel cell stack (12) is sensed.

7. The method of starting up a fuel cell system as set forth in any of the preceding claims, characterized in that a value as established empirically as a function of the operating time of the fuel cell system is used as the temperature of the fuel cell stack (12).

8. A fuel cell system comprising a reformer (10) and a fuel cell stack (12), the reformer receiving a supply of fuel (14) and air (16) as the starting materials and the fuel cell stack (12) receiving a supply of reformate (18) generated by the reformer, characterized in that the air ratio characterizing the fuel/air ratio of the starting materials supplied to the reformer (10) is variable as a function of a temperature of the fuel cell stack (12)).

9. The fuel cell system as set forth in claim 8, characterized in that the fuel cell system comprises an electronic controller (20).

10. The fuel cell system as set forth in claim 8 or 9, characterized in that the dependence of the air ratio to be varied from the temperature is saved in a memory (22) belonging to the electronic controller (20).

11. The fuel cell system as set forth in any of the claims 8 to 10, characterized in that the air ratio can be reduced with increasing temperature of the fuel cell stack (12).

12. The fuel cell system as set forth in any of the claims 8 to 11, characterized in that on start-up of the fuel cell system an air ratio in the range 1.3 to 1.5 can be set and that after having attained the operating temperature of the fuel cell stack (12) an air ratio can be set in the range 0.3 to 0.5.

13. The fuel cell system as set forth in any of the claims 8 to 12, characterized in that the air ratio can be reduced incrementally with increasing temperature of the fuel cell stack (12).

14. The fuel cell system as set forth in any of the claims 8 to 13, characterized in that the air ratio can be reduced continuously with increasing temperature of the fuel cell stack (12).

15. The fuel cell system as set forth in any of the claims 8 to 14, characterized in that at least one temperature sensor (24) is provided for sensing the temperature of the fuel cell stack (12).

16. The fuel cell system as set forth in any of the claims 8 to 15, characterized in that a value as established empirically as a function of the operating time of the fuel cell system can be used as the temperature of the fuel cell stack (12), the values being made available by a memory (22) as a component of the electronic controller (20).
